(19) United States
(12) Patent Application Publication
(10) Pub. No.: US 2017/0221268 A1
(43) Pub. Date: Aug. 3, 2017

(54) BEHAVIOR TRACKING AND MODIFICATION USING MOBILE AUGMENTED REALITY

(71) Applicant: HEWLETT PACKARD ENTERPRISE DEVELOPMENT LP, Houston, TX (US)

(72) Inventors: Charles Edgar BESS, Frisco, TX (US); William J. ALLEN, Corvallis, OR (US)

(73) Assignee: HEWLETT PACKARD ENTERPRISE DEVELOPMENT LP, Houston, TX (US)

(21) Appl. No.: 15/306,734

(22) PCT Filed: Sep. 26, 2014
(86) PCT No.: PCT/US2014/057805

§ 371 Date: Oct. 25, 2016

(51) Int. Cl. G06T 19/00; G06T 11/60; G01C 21/36; G06F 3/0346; G01C 21/34; H04W 4/02; G06K 9/00

(52) U.S. Cl. CPC G06T 19/006; H04W 4/026; G06T 11/60; G06K 9/00624; G06F 3/0346; G01C 21/3407; G01C 21/3682

(57) ABSTRACT

Examples relate to behavior tracking and modification using mobile augmented reality. In some examples, a navigation request for a route to a destination location is received from a user, and a data stream associated with the user is obtained. A first waypoint is identified based on the data stream and first waypoint metadata of a number of waypoint metadata that each include recognition cues for identifying a corresponding waypoint. An orientation of the user is determined based on the data stream and the recognition cues in the first waypoint metadata. A second waypoint is determined based on the characteristics in second waypoint metadata, and a guidance overlay is generated for display to the user based on the orientation, where the guidance overlay specifies a direction and a distance to the second waypoint.

### BACKGROUND

Consumer mobile devices, such as smartphones and optical head mounted displays, are often used for navigation. Typically, positioning technology such as the global positioning system (GPS) or radio triangulation are used by such devices to facilitate moving the user from a start location to a destination location with turn-by-turn directions. In some cases, routes can be dynamically modified to reduce the estimated travel time. Further, some of these navigation devices are capable of augmented reality (AR), which extends the interaction of a user with the real world by combining virtual and real elements.

### BRIEF DESCRIPTION OF THE DRAWINGS

The following detailed description references the drawings, wherein:

FIG. 1 is a block diagram of an example mobile computing device for behavior tracking and modification using mobile augmented reality;

FIG. 2 is a block diagram of an example system for behavior tracking and modification using mobile augmented reality;

FIG. 3 is a flowchart of an example method for execution by a mobile computing device for behavior tracking and modification using mobile augmented reality;

FIG. 4 is a flowchart of an example method for execution by a mobile computing device for behavior tracking and modification using mobile augmented reality for waypoint navigation; and

FIG. 5 is a block diagram of an example user interface for behavior tracking and modification using mobile augmented reality.

### DETAILED DESCRIPTION

As discussed above, augmented reality can be used to provide heads-up navigation. However, real-time navigation can be distracting and hazardous to the user. Further, navigation techniques typically use shortest time or distance algorithms to determine navigation routes, which have predetermined intermediate locations based on the algorithm used.

It would be useful to provide branching or to support alternate paths based on the characteristics of the user or the environment that is being traversed. Examples disclosed herein provide an approach to prioritize and provide feedback to the user with a point system that enables the user to make choices and be rewarded in real-time for desired behavior. Such a feedback system can be based on a variety of characteristics such as congestion avoidance, educational, entertainment, nourishment, promptness, and safety. The feedback informs the user about his choices and the possible implications or benefits.

In some examples, a navigation request for a route to a destination location is received from a user, and a data stream associated with the user is obtained. A first waypoint is recognized based on the data stream and first waypoint metadata of a number of waypoint metadata that each include recognition cues for identifying a corresponding waypoint. An orientation of the user is determined based on the data stream and the recognition cues in the first waypoint metadata. A second waypoint is determined based on the characteristics in second waypoint metadata, and a guidance overlay is generated for display to the user based on the orientation, where the guidance overlay specifies a direction and a distance to the second waypoint.

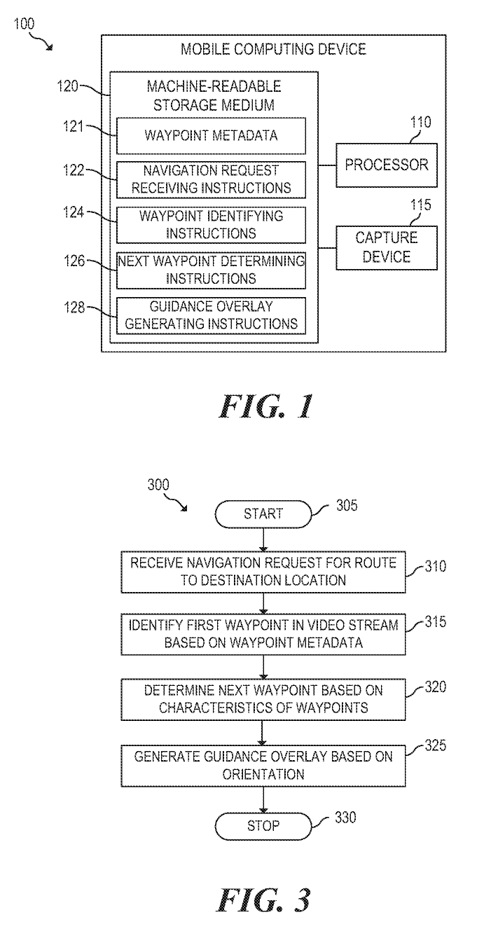

Referring now to the drawings, FIG. 1 is a block diagram of an example mobile computing device 100 for behavior tracking and modification using mobile augmented reality. The example mobile computing device 100 may be a smartphone, optical head mounted display, tablet, or any other electronic device suitable for providing mobile AR. In the embodiment of FIG. 1, mobile computing device 100 includes processor 110, capture device 115, and machine-readable storage medium 120.

Processor 110 may be one or more central processing units (CPUs), microprocessors, and/or other hardware devices suitable for retrieval and execution of instructions stored in machine-readable storage medium 120. Processor 110 may fetch, decode, and execute instructions 122, 124, 126, 128 to enable behavior tracking and modification using mobile augmented reality. As an alternative or in addition to retrieving and executing instructions, processor 110 may include one or more electronic circuits comprising a number of electronic components for performing the functionality of one or more of instructions 122, 124, 126, 128.

Capture device 115 is configured to capture a data stream associated with the user. For example, capture device 115 may include an image sensor that is capable of capture a video stream in real-time as the user repositions the mobile computing device 100. In this example, mobile computing device 100 can be configured to display virtual overlays in the video stream as described below.

Machine-readable storage medium 120 may be any electronic, magnetic, optical, or other physical storage device that stores executable instructions. Thus, machine-readable storage medium 120 may be, for example, Random Access Memory (RAM), Content Addressable Memory (CAM), Ternary Content Addressable Memory (TCAM), an Electrically-Erasable Programmable Read-Only Memory (EEPROM), flash memory, a storage drive, an optical disc, and the like. As described in detail below, machine-readable storage medium 120 may be encoded with executable instructions for behavior tracking and modification using mobile augmented reality.

Waypoint metadata 121 include recognition cues that can be used to identify waypoints in an area of interest. Waypoints are identifiable objects in the area of interest that can be used to navigate a user along a traveling route (i.e., provide instructions to the user for traveling from waypoint to waypoint until his destination is reached). Waypoints may be landmarks such as statues or trees, flags, quick response (QR) codes, etc. Examples of recognition cues include geometric properties, edge information, gradient information, histogram information, location information, etc. For example, geometric properties can be used to perform object recognition to identify a waypoint in the area of interest. In another example, location information can be used to identify a waypoint in the area of interest based on proximity to the user.

Navigation request receiving instructions 122 receives a navigation request from a user of mobile computing device 100. The navigation request includes a destination location that has been specified for or by the user. The navigation request may also include a start location and a user preference for characteristics of the waypoints to be determined as described below. Examples of navigation requests include, but are not limited to, a request for a tour through a museum, a request for walking directions through a park, a request for a route through a convention, etc.

Waypoint identifying instructions 124 identifies a waypoint in the video stream of the capture device 115. For example, mobile computing device 100 may be preconfigured with waypoint metadata that includes recognition cues (i.e., preconfigured with visual characteristics of items of interest) for waypoints such as landmarks, flags, quick response (QR) codes, etc. Waypoint identifying instructions 124 may use the recognition cues to identify waypoints in the video stream in real-time as the user repositions the camera.

Waypoint identifying instructions 124 also determines the orientation of the capture device 115 with respect to the identified waypoint. Again, recognition cues associated with the waypoint can be used to determine the orientation of the capture device 115 by identifying the positioning of waypoint characteristics that are visible in the video stream. Because the position and orientation of the waypoint is known, the position and orientation of the camera relative to the waypoint can be determined. The orientation of the capture device 115 is updated in real-time as the mobile computing device 100 is repositioned.

Next waypoint determining instructions 126 determines a next waypoint in the route of the user based on characteristics of the waypoint. For example, if there is a lot of congestion in the area, the next waypoint can be determined to minimize overall congestion. In another example, if the user has indicated that he is hungry, the next waypoint determined may be a food vendor. In some cases, the characteristics of all potential waypoints can be considered and weighed against each other while determining the next waypoint.

Guidance overlay generating instructions 128 generates a guidance overlay that directs the user of mobile computing device 100 to the next waypoint. The guidance overlay may, for example, include a directional arrow and a distance to the next waypoint. The guidance overlay is generated based on the orientation of the capture device 115 with respect to the identified waypoint in the video stream. In other words, the position of the user can be determined based on the orientation of the capture device 115, which is then used to determine the direction and distance of the next waypoint for the guidance overlay.

In this example, a video stream of capture device 115 is used to determine the position and orientation of the mobile computing device 100; however, other data streams can be used to determine the position and orientation. For example, a positioning stream captured by a GPS device can be used to determine the position and orientation. In another example, a radio frequency (RF) stream from wireless routers, Bluetooth receivers, wireless adapters, etc. can be used to determine the position and orientation.

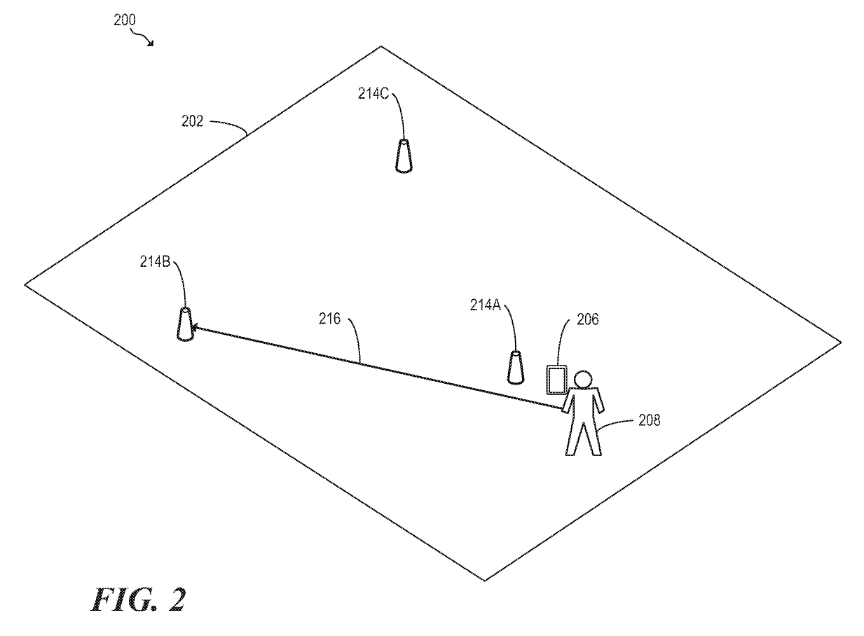

FIG. 2 is a block diagram of an example system 200 including a mobile computing device 206 and waypoints 214A-214C for behavior tracking and modification using mobile augmented reality in an area of interest 202. As with mobile computing device 100 of FIG. 1, mobile computing device 206 may be implemented on any electronic device suitable for behavior tracking and modification using mobile augmented reality. The components of mobile computing device 206 may be similar to the corresponding components of mobile computing device 100 described with respect to FIG. 1.

Area of interest 202 may be any enclosed, indoor area such as a convention center or museum or an outdoor area such as a park or downtown of a city. In this example, area of interest 202 is a park including a number of waypoints 214A-214C. Each waypoint 214A may be a point of interest such as a monument, QR code, tree, etc. The position of waypoints 214A-214C may be designated in a map of the area of interest 202, where the map is a two-dimensional or three-dimensional representation of the area of interest 202. In other embodiments, other items of interest such as restaurants, water fountains, bathrooms, etc. may also be included in the map, which can be stored in mobile computing device 206 or in a storage device (not shown) that is accessible to mobile computing device 206. Recognition cues describing each of the waypoints 214A-214C may also be stored in mobile computing device 206 or accessible storage device. Examples of recognition cues include geometric properties, edge information, gradient information, histogram information, location information, etc. The recognition cues are configured to be used by mobile computing device 206 to perform object recognition.

Mobile computing device 206 may be configured to provide mobile augmented reality for mobile user 208. For example, mobile computing device 206 may display a video stream captured by a camera for view by mobile user 208, where the video stream includes visual overlays. Mobile computing device 206 includes an object recognition module for recognizing waypoints 214A-214C in the video stream. The waypoints can be recognized using characteristics stored in mobile computing device 206 or a storage device that is accessible to mobile computing device 206 over, for example, the Internet.

Mobile computing device 206 may also be configured to determine traveling routes (e.g., route 216 from waypoint A 214A to waypoint B 214C) for mobile user 208 based on the map and characteristics of the waypoints 214A-214C. Characteristics of the waypoints 214A-214C include information such as an educational value of a waypoint, a popularity of a waypoint, an entertainment value of a waypoint, current congestion at a waypoint, a nourishment value of a waypoint, a location of a waypoint, etc. For example, a painting in a museum may have a high educational and entertainment value. In another example, a restaurant may have a high entertainment, nourishment, and congestion value. Mobile computing device 206 may allow user to specify route preferences, which are then used to determine the waypoints that should be determined for a traveling route.

Mobile user 208 may be positioned in and moving about area of interest 202. For example, mobile user 208 may be attending a convention at a convention center. Mobile user 208 may have a mobile user device 206 such as a tablet or smartphone that is equipped with a camera device. Mobile user device 206 may include a reality augmentation module to provide mobile AR to mobile user 208 as he travels in area of interest 202. For example, the reality augmentation module of mobile user device 206 may display a video stream with guidance overlays directing the user along a traveling route. The guidance overlay can be updated based on the waypoint (e.g., waypoint A 214A, waypoint B 214B, waypoint C 214C) that is currently visible in the video stream.

As mobile user 208 reaches waypoints, mobile computing device 206 may be configured to provide achievements and/or other rewards to the user (i.e., gamification). Such rewards may encourage the user to modify his behavior in such a way that is beneficial to the area such as reducing overall congestion, driving traffic to targeted businesses, etc. Mobile computing device 206 may also be configured to reroute the mobile user 208 to a new set of waypoints if the mobile user 208 ignores the recommended waypoint and reaches a different waypoint. In this manner, the traveling route of the mobile user 208 can be dynamically modified based on whether the mobile user 208 chooses to follow the recommendations in the guidance overlay.

In some cases, mobile user device 206 may also use other positioning data in addition to or rather than object recognition to determine the location of mobile user. Examples of other positioning data include RF data from wireless routers, Bluetooth receivers, wireless adapters, etc. or global positioning system (GPS) data. The RF data may include RF signal data (e.g., signal strength, receiver sensitivity, etc.) and may be used to enhance the location determined by mobile user device 206 based on the video stream. For example, the RF data may be used to perform RF triangulation to more accurately determine the position of mobile user device 206.

FIG. 3 is a flowchart of an example method 300 for execution by a mobile computing device 100 for behavior tracking and modification using mobile augmented reality. Although execution of method 300 is described below with reference to mobile computing device 100 of FIG. 1, other suitable devices for execution of method 300 may be used, such as mobile computing device 206 of FIG. 2. Method 300 may be implemented in the form of executable instructions stored on a machine-readable storage medium and/or in the form of electronic circuitry.

Method 300 may start in block 305 and continue to block 310, where mobile computing device 100 receives a navigation request from a user of mobile computing device 100. The navigation request includes a destination location that has been specified by the user. In block 315, a waypoint is identified in the video stream of the capture device 115. For example, recognition cues in waypoint metadata can be used by an object recognition module to identify the waypoint. In another example, location data in the waypoint data can be used to identify the waypoint because it is near the user. The orientation of the mobile computing device's 100 camera with respect to the identified waypoint is also determined. Again, recognition cues associated with the waypoint can be used to determine the orientation of the camera.

In block 320, the next waypoint in a traveling route of the user is determined based on characteristics (e.g., educational value, entertainment value, congestion, etc.) of the waypoints. For example, if a particular exhibit in a museum has low congestion, the exhibit with low congestion can be favored when determining the route of the user. In this example, various goal optimization algorithms can be used to facilitate decision making such has applying weighted values for various waypoints and maximizing results based on the weighted values or more complex approaches like Pareto optimization or Monte Carlo simulations.

In block 325, a guidance overlay that directs the user of mobile computing device 100 to the next waypoint is displayed. Method 300 may subsequently proceed to block 330, where method 300 may stop.

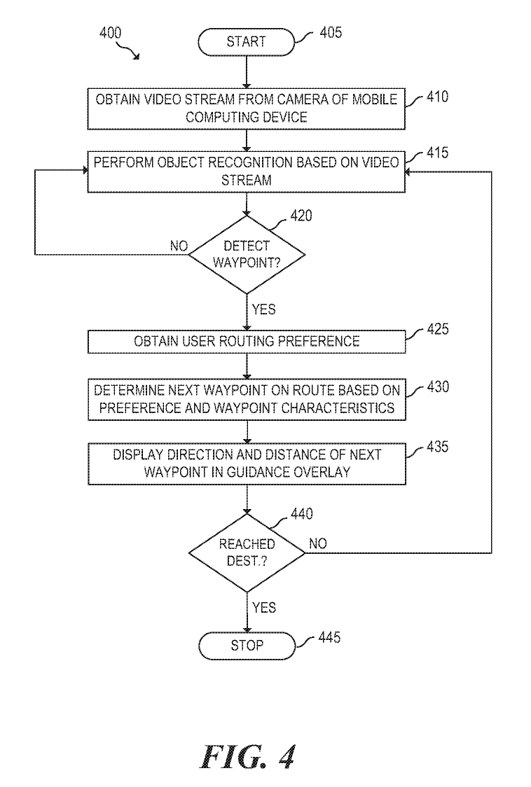

FIG. 4 is a flowchart of an example method 400 for execution by a mobile computing device 206 for behavior tracking and modification using mobile augmented reality for waypoint navigation. Although execution of method 400 is described below with reference to mobile computing device 206 of FIG. 2, other suitable devices for execution of method 400 may be used, such as mobile computing device 100 of FIG. 1. Method 400 may be implemented in the form of executable instructions stored on a machine-readable storage medium and/or in the form of electronic circuitry.

Method 400 may start in block 405 and continue to block 410, where mobile computing device 206 obtains a video stream from a camera of the mobile computing device 206. The video stream is captured by a user in an environment that includes known waypoints, where the mobile computing device 206 is preconfigured with recognition cues for the waypoints. In block 415, mobile computing device 206 performs object recognition of the video stream. Specifically, the recognition cues are used to determine if any waypoints are in the current field of view of the camera.

In block 420, mobile computing device 206 determines if a waypoint is detected in the video stream. If there is no waypoint in the video stream, method 400 returns to block 415 to continue performing object recognition. If there is a waypoint in the video stream, mobile computing device 206 obtains a user routing preference for generating a traveling route for the user in block 425. The user routing preferences specifies that the traveling routes should satisfy objectives such as congestion avoidance, educational, entertainment, nourishment, promptness, and/or safety. In some cases, the user may specify multiple user routing preferences. For example, the user may specify that the traveling route should include nourishment while being at least 3 kilometers in total distance.

In block 430, mobile computing device 206 determines the next waypoint based on the user routing preference and waypoint characteristics. The characteristics of each waypoint can include educational value of the waypoint, a popularity of the waypoint, an entertainment value of the waypoint, current congestion at the waypoint, a nourishment value of the waypoint, etc. The next waypoint is determined so that the user preference is optimally satisfied (e.g., locating the nearest waypoint with a high nourishment value if the user routing preference includes a nourishment objective).

In block 435, the direction and distance to the next waypoint is displayed on mobile computing device 206 in a guidance overlay. Mobile computing device 206 may also display any achievements or rewards that were obtained by the user for reaching the waypoint. While the user is traveling to the next waypoint, mobile computing device 206 may be configured to operate hands-free. For example, mobile computing device 206 may provide directional guidance by voice message or accept voice commands for rerouting, updating user routing preferences, etc.

In block 440, mobile computing device 206 determines if the user has reached the destination of the traveling route. If the user has not reached the destination, method 400 can return to block 415, where mobile computing device 206 continues to perform object recognition for waypoints. If the user has reached the destination, method 400 may proceed to block 445 and stop.

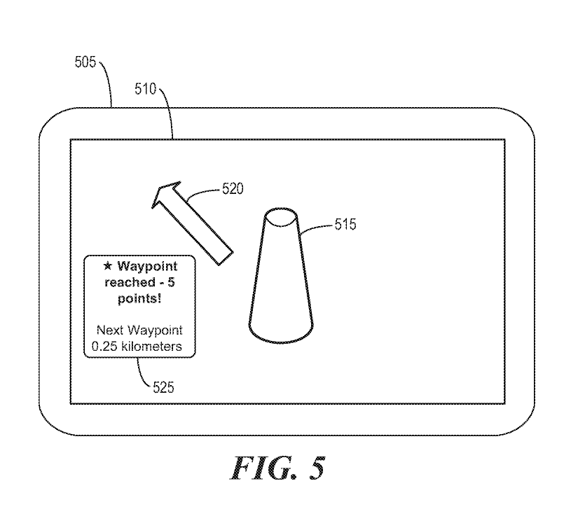

FIG. 5 is a block diagram of an example mobile computing device 505 for behavior tracking and modification using mobile augmented reality. Mobile computing device 505 includes a user display 510 showing a waypoint 515, directional arrow 520, and a waypoint information message 525. In this example, the video stream of mobile computing device 505 shows the waypoint 515 in the center of the user display. Accordingly, mobile computing device 505 can determine the user's location/orientation with respect to the waypoint 515. Mobile computing device 505 can also determine a next waypoint for a traveling route of the user, where the directional arrow 520 indicates the direction toward the next waypoint.

Waypoint information message 525 shows that the user has been rewarded five points for reaching the waypoint 525. The points may be rewarded because the user has, for example, relieved overall congestion in the area by traveling to the waypoint 525. Waypoint information message 525 also shows that the next waypoint is 0.25 kilometers in the direction of the direction arrow 520. As the user travels, the user display 510 can be updated to, for example, reflect a change in the user's position, a new waypoint that is dynamically determined based on changing characteristics, etc. Further, when the user reaches the next waypoint, the user display 510 can be updated for a further waypoint and so on. In this manner, the user is directed from waypoint to waypoint until a destination of the traveling route is reached.

The foregoing disclosure describes a number of example embodiments for behavior tracking and modification using mobile augmented reality. In this manner, the examples disclosed herein user navigation by providing waypoint navigation that encourages the user to use routes based on characteristics of the waypoints.

We claim:

1. A system for behavior tracking and modification using mobile augmented reality, comprising:
a capture device to obtain a data stream associated with a user;
a memory configured to store a plurality of waypoint metadata that each include recognition cues for identifying a corresponding waypoint of a plurality of waypoints based on the data stream and characteristics of the corresponding waypoint; and
a processor operatively connected to the memory, the processor to:
receive a navigation request for a route to a destination location;
identify a first waypoint of the plurality of waypoints based on the data stream and first waypoint metadata of the plurality of waypoint metadata;
determine an orientation of the user based on the data stream and the recognition cues in the first waypoint metadata;
determine a second waypoint of the plurality of waypoints based on the characteristics in second waypoint metadata of the plurality of waypoint metadata; and
generate a guidance overlay for display to the user based on the orientation, wherein the guidance overlay specifies a direction and a distance to the second waypoint.

2. The system of claim 1, wherein the navigation request includes a user objective selected from a group consisting of congestion avoidance, educational, entertainment, nourishment, promptness, and safety, wherein the second waypoint is further based on the user objective.

3. The system of claim 1, further comprising a user display that is configured to be hands-free while a user travels from the first waypoint to the second waypoint.

4. The system of claim 1, wherein the capture device is a camera configured to obtain a video stream of a user view, and wherein the identification of the first waypoint is performed by applying object recognition to the video stream.

5. The system of claim 1, wherein the processor is further to provide a game reward to the user when the first waypoint is identified based on the data stream and the first waypoint metadata.

6. The system of claim 1, wherein the second way point is determined using a Pareto optimization or a Monte Carlo simulation.

7. A method for behavior tracking and modification using mobile augmented reality, comprising:
receiving a navigation request for a route to a destination location for a user;
obtaining a data stream associated with the user;
identifying a first waypoint of a plurality of waypoints based on the data stream and first waypoint metadata of a plurality of waypoint metadata that each include recognition cues for identifying a corresponding waypoint of the plurality of waypoints;
determining an orientation of the user based on the data stream and the recognition cues in the first waypoint metadata;
determining a second waypoint of the plurality of waypoints based on the characteristics in second waypoint metadata of the plurality of waypoint metadata; and
generating a guidance overlay for display to the user based on the orientation, wherein the guidance overlay specifies a direction and a distance to the second waypoint.

8. The method of claim 7, wherein the navigation request includes a user objective selected from a group consisting of congestion avoidance, educational, entertainment, nourishment, promptness, and safety, wherein the second waypoint is further based on the user objective.

9. The method of claim 7, wherein the capture device is a camera configured to obtain a video stream of a user view, and wherein the identification of the first waypoint is performed by applying object recognition to the video stream.

10. The method of claim 7, further comprising providing a game reward to the user when the first waypoint is identified based on the data stream and the first waypoint metadata.

11. The method of claim 7, wherein the second way point is determined using a Pareto optimization or a Monte Carlo simulation.

12. A non-transitory machine-readable storage medium encoded with instructions executable by a processor for behavior tracking and modification using mobile augmented reality, the machine-readable storage medium comprising instruction to:
receive a navigation request for a route to a destination location for a user;
obtain a video stream associated with the user from a camera;
identify a first waypoint of a plurality of waypoints in the video stream base on first waypoint metadata of a plurality of waypoint metadata that each include recognition cues for identifying a corresponding waypoint of the plurality of waypoints;
determine an orientation of the user based on the video stream and the recognition cues in the first waypoint metadata;
determine a second waypoint of the plurality of waypoints based on the characteristics in second waypoint metadata of the plurality of waypoint metadata; and
generate a guidance overlay for display to the user based on the orientation, wherein the guidance overlay specifies a direction and a distance to the second waypoint.

13. The non-transitory machine-readable storage medium of claim 12, wherein the navigation request includes a user objective selected from a group consisting of congestion avoidance, educational, entertainment, nourishment, promptness, and safety, wherein the second waypoint is further based on the user objective.

14. The non-transitory machine-readable storage medium of claim 12, wherein the instructions are further to provide a game reward to the user when the second waypoint is identified in the video stream based on the second waypoint metadata.

15. The non-transitory machine-readable storage medium of claim 12, wherein the second way point is determined using a Pareto optimization or a Monte Carlo simulation.
